(19) United States
(12) Patent Application Publication
(10) Pub. No.: US 2008/0126753 A1
(43) Pub. Date: May 29, 2008

(54) EMBEDDED SYSTEM AND OPERATING METHOD THEREOF

(75) Inventors: Ming-Yang Chao, Hsin-Chu Hsien (TW); Chien-Hsun Tung, Taichung City (TW); Pao-Ching Tseng, Hsinchu County (TW); Ching Yi Wu, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/534,811

(22) Filed: Sep. 25, 2006

(51) Int. Cl. G06F 15/76; G06F 9/02

(52) U.S. Cl. 712/34; 712/E09.002

(57) ABSTRACT

An embedded system and an operating method thereof are disclosed. The embedded system comprises a micro-processor and a co-processor. The co-processor can only process non-interruptible instructions. The micro-processor is powered by an operating system to control the embedded system. When a task requires execution, the micro-processor appoints the co-processor to execute at least one batch command block. The batch command block is compiled with a sequence of non-interruptible instructions. When the task is complete, the co-processor outputs a response signal to the micro-processor.

### BACKGROUND OF THE INVENTION

1. Field of the Invention

The invention relates to embedded systems, and in particular, to a programmable co-processor architecture.

2. Description of the Related Art

FIG. 1 shows a conventional embedded system 100. The embedded system 100 may be a DVD-ROM, a portable mp3 player or any digital apparatus, in which, micro-processor 110 is powered by an operating system to serve the embedded system 100. A plurality of ASICs (102 and 104) may be provided to perform specific operations, such as encoding, decoding or arithmetical calculations. The micro-processor 110 controls the ASICs 102 and 104 by control signals delivered over pins or a system bus. The disadvantage of the architecture is, individually implementing an ASIC for each application is cost inefficient.

FIG. 2 shows a conventional embedded system 200 utilizing a dual CPU architecture. In the embedded system 200, the first processor 210 executes an operating system to provide major controllability and functionality. Specific operations such as encoding, decoding or arithmetical calculations are packaged in a plurality of context blocks 202 and stored in the memory device 240. A context block 202 may be a program destined to accomplish a specific operation, comprising a sequence of micro-processor instructions and application data. When a specific operation is required, the first processor 210 programs the second processor 220 with a corresponding context block 202, and the second processor 220 becomes a temporary ASIC providing functionalities defined by the context block 202. The first processor 210 programs the second processor 220 by a switch signal #SW_IN to make the second processor 220 work, and continues running the operating system while the second processor 220 is working. The embedded system 200 provides more flexibility than the embedded system 100, however, for most embedded systems, the context blocks 202 are just simple instruction sequences, and the second processor 220 is too high end for the simple context block 202s. Executing simple instructions using high end second processor 220 may be deemed wasteful. Thus, a simplified architecture is desirable.

### BRIEF SUMMARY OF THE INVENTION

Embedded systems are provided. An exemplary embodiment of an embedded system comprises a micro-processor and a co-processor. The co-processor processes only non-interruptible instructions. The micro-processor is powered by an operating system to control the embedded system. When task requires completing, the micro-processor appoints the co-processor to execute at least one batch command block. The batch command block is compiled with a sequence of non-interruptible instructions. When the task is complete, the co-processor outputs a response signal to the micro-processor.

The embedded system may further comprise a memory device storing a plurality of batch command blocks corresponding to at least one task. When a task is assigned to the co-processor, the corresponding batch command block(s) is/are fetched by the co-processor for execution.

The co-processor comprises a command queue, an execution engine and a support engine. The command queue queues non-interruptible instructions to be executed. The execution engine sequentially executes the non-interruptible instructions queued in the command queue. The support engine is accessed by the micro-processor to control the execution engine's execution flow.

Initially, the micro-processor sets a starting address of a batch command block corresponding to the task and sends an initial signal to the support engine. The support engine may comprise an address register for storage of the starting address, and the support engine fetches the batch command block according to the starting address. The execution engine is triggered to execute the non-interruptible instructions as long as the command queue is not empty. The support engine sends a response signal to the micro-processor upon completion of the task.

The micro-processor compiles the non-interruptible instructions or fetches the non-interruptible instructions from non-volatile memory to generate the batch command block and stores it in the memory device before sending the initial signal to the support engine. The response signal indicates an execution result or an exception event of the task. The micro-processor is interrupted by the response signal to take over the co-processor.

The non-interruptible instructions may comprise fundamental arithmetic instructions, memory access instructions and flow control instructions. The execution engine executes the fundamental arithmetic instructions, memory access instructions and flow control instructions. The embedded system may be a DVD-ROM, and the task may be a mechanic control operation thereof Alternatively, the embedded system may be an audio device, and the task may be a decoding process comprising arithmetic operations of adding, subtracting, multiplying and dividing.

A further embodiment provides an operating method based on the embedded system. A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a conventional embedded system 100;

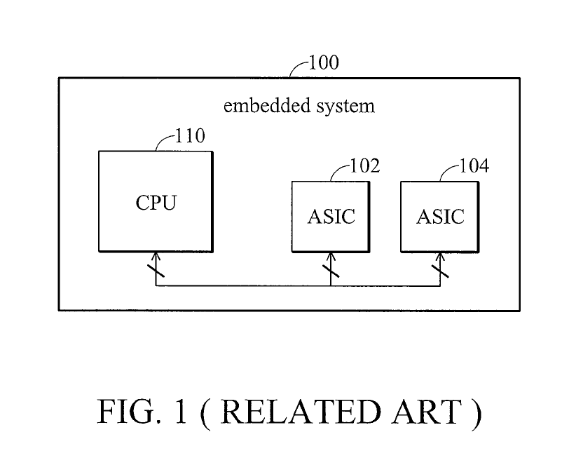

FIG. 2 shows a conventional embedded system 200;

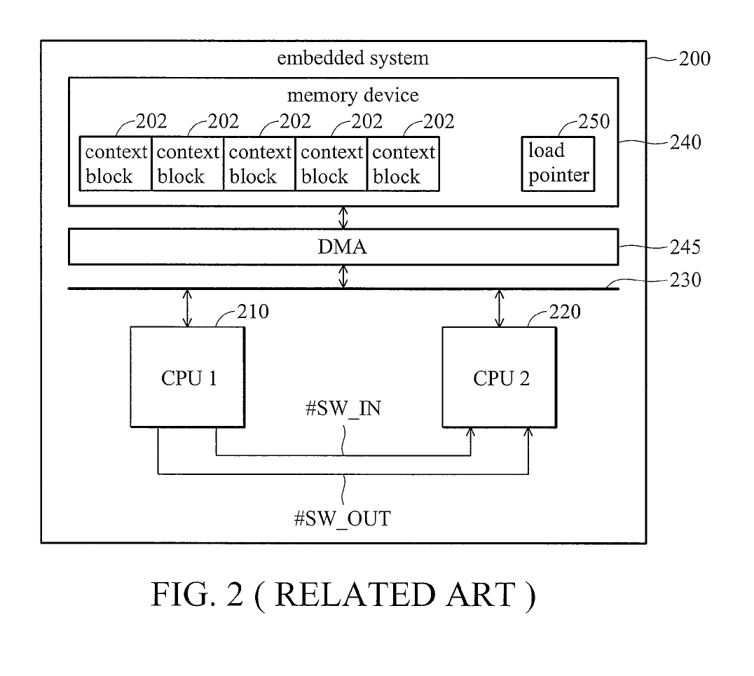

FIG. 3 shows an embodiment of a embedded system 300; and

FIG. 4 is a flowchart of an operating method according to the embedded system 300 in FIG. 3.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

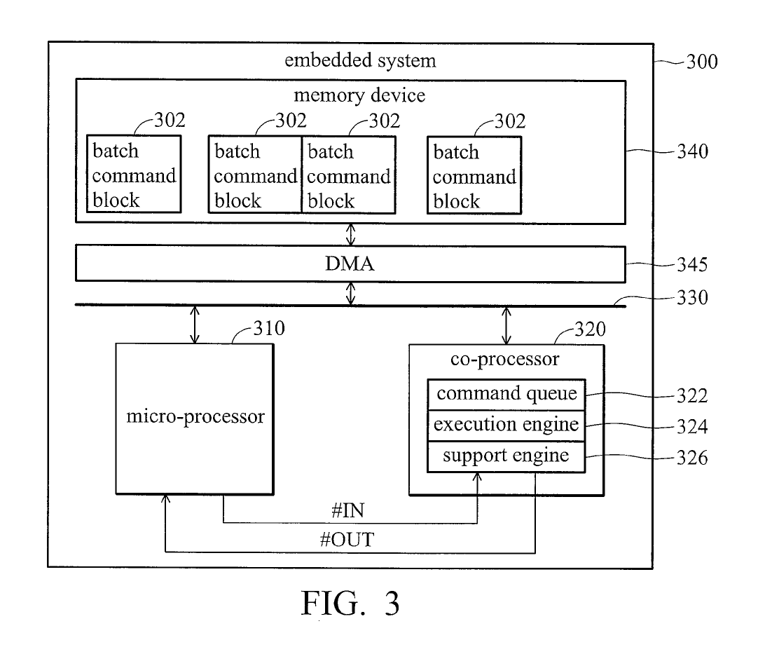

FIG. 3 shows an embodiment of a embedded system 300 comprising a micro-processor 310 and a co-processor 320. The micro-processor 310 is powered by an operating system embedded in the embedded system 300. The co-processor 320 is a simplified processor capable of processing only non-interruptible instructions. A non-interruptible instruction is defined to be sequentially executable without interrupting. Since no interrupt is required, and the codes are sequentially executed, the co-processor 320 does not need a program counter and a stack, and the implementation cost is reduced. The task is a program or application compiled into a batch command block 302, comprising a sequence of non-interruptible instructions and application data. Each task may be accomplished by executing one or more batch command blocks 302. Through an initial signal #IN, the micro-processor 310 appoints the co-processor 320 to execute the batch command blocks 302 in the memory device 240 to accomplish a task. When the task is complete, the co-processor 320 outputs a response signal #OUT to the micro-processor 310. The micro-processor 310 continues running the operating system before the response signal #OUT is sent from the co-processor 320, thus the executions in the co-processor 320 does not occupy computational resources of the micro-processor 310.

The batch command blocks 302 are stored in the memory device 240. The memory device 240 may be a DRAM device for storing batch command blocks 302 dynamically compiled from the micro-processor 310. Alternatively, the memory device 240 may also be a read only memory such as firmware, with predefined batch command blocks 302 burned therein. In other case, the batch command blocks 302 may be provided externally, or instantly generated by the micro-processor 310 when needed. The co-processor 320 comprises a command queue 322, an execution engine 324 and a support engine 326. The support engine 326 is accessed by the micro-processor 310 to control the execution engine's execution flow. For example, execution flow comprises trigger start, pause execution and/or reset macro. When the micro-processor 310 delivers initial signal #IN to the support engine 326, appointing the signal to a batch command block 302, the command queue 322 fetches the batch command block 302 and extracts the non-interruptible instructions. As long as the command queue 322 is not empty, the execution engine 324 sequentially executes the non-interruptible instructions queued in the command queue 322. The initial signal #IN triggers the start of the execution engine 324, and the support engine 326 comprises an address register for storage of the starting address. According to the starting address, the command queue 322 can precisely locate the batch command block 302 and fetch it from the memory device 240. The support engine 326 determines whether the task is complete when the command queue 322 is empty. If the command queue 322 is empty, and the task is not complete, the co-processor is idle and waiting for the command queue being filled. When the task is complete, the support engine 326 sends a response signal #OUT to the micro-processor 310.

The response signal #OUT may be an interrupt or a polling signal to indicate the micro-processor 310 an execution result is available, or an exception is occurring in the co-processor 320. When the micro-processor 310 receives the response signal #OUT, its normal operation is interrupted to take over the co-processor 320. For example, the co-processor 320 may put an execution result in the memory device 240, and delivers the response signal #OUT to inform the micro-processor 310 to fetch it.

The non-interruptible instructions may be categorized into fundamental arithmetic instructions, memory access instructions and flow control instructions. The fundamental arithmetic instructions are typically adding, subtracting, multiplying and dividing. The memory access instructions are read and write of memory unit, and the flow control instructions may include simply jump or loop. The fundamental arithmetic instructions, the memory access and flow control are executed by the execution engine 324. Thus, when the non-interruptible instructions are extracted into the command queue 322, the execution engine 324 executes them. As an example, if the task is a mechanical control operation of a DVD-ROM, the co-processor 320 becomes a temporary ASIC when programmed by the predefined batch command block 302. If the embedded system 300 is an mp3 player, and the task is audio decoding, the co-processor 320 becomes a decoder performing arithmetic operations on the audio data when programmed by the corresponding context block 202. Various applications may be defined by compiling non-interruptible instructions into the batch command block 302, and the embedded system is not limited to the described embodiments.

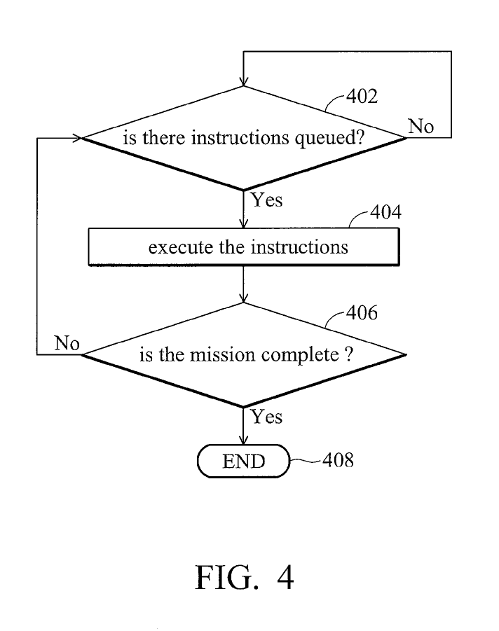

FIG. 4 is a flowchart of an operating method for the embedded system 300 of FIG. 3. In step 402, the command queue 322 is recursively monitored whether it is empty or if there is a queue. The micro-processor 310 may appoint one or more batch command blocks 302 to the co-processor 320 by the initial signal #IN, and the command queue 322 fetches the batch command blocks 302 into the command queue 322 accordingly. If any non-interruptible instruction exists in the command queue 322, the execution engine 324 executes the instructions in step 404. In step 406, it is determined whether the task is accomplished. If not, the process returns to step 402, to await more queued instructions. If the task is complete, the support engine 326 sends a response signal #OUT to the micro-processor 310 in step 408, informing the micro-processor 310 to take over the successive processes. In summary, the disclosed embodiments provide a programmable co-processor 320 flexibly performing various predefined applications compiled in non-interruptible instructions. The cost is lower than that of a dual-CPU architecture.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An embedded system, comprising:
a co-processor, capable of processing only non-interruptible instructions; and
a micro-processor, powered by an operating system to control the embedded system, and appointing the co-processor to execute at least one batch command block to accomplish a task; wherein:
the batch command block is compiled with a sequence of non-interruptible instructions; and
when the task is complete, the co-processor outputs a response signal to the micro-processor.

2. The embedded system as claimed in claim 1, further comprising a memory device, storing a plurality of batch command blocks corresponding to at least one task; wherein when a task is assigned to the co-processor, the corresponding batch command block(s) is/are fetched by the co-processor for execution.

3. The embedded system as claimed in claim 2, wherein the co-processor comprises:
a command queue, queuing non-interruptible instructions to be executed;
an execution engine, sequentially executing the non-interruptible instructions queued in the command queue; and
a support engine, accessed by the micro-processor to control the execution engine's execution flow.

4. The embedded system as claimed in claim 3, wherein:
the micro-processor sets the starting address of a batch command block corresponding to the task and sends an initial signal to the support engine.
the support engine comprises an address register for storage of the starting address;
the command queue fetches the batch command block according to the starting address, and extracts the non-interruptible instructions;
the execution engine is triggered to execute the non-interruptible instructions as long as the command queue is not empty; and
the support engine sends a response signal to the micro-processor upon completion of the task is complete.

5. The embedded system as claimed in claim 4, wherein:
the micro-processor compiles the non-interruptible instructions to generate the batch command block and stores it in the memory device before sending the initial signal to the support engine;
the response signal indicates an execution result or an exception event of the task; and
the micro-processor is interrupted by the response signal to take over the co-processor.

6. The embedded system as claimed in claim 3, wherein:
the non-interruptible instructions comprise fundamental arithmetic instructions, memory access instructions and flow control instructions;
the execution engine executes the fundamental arithmetic instructions, the memory access instructions and flow control instructions.

7. The embedded system as claimed in claim 6, wherein the task is a mechanic control operation of an optical disk drive.

8. The embedded system as claimed in claim 6, wherein the task is an arithmetic operation of adding, subtracting, multiplying and dividing.

9. An operating method for accomplishing a task using in a embedded system comprising a co-processor and a micro-processor, wherein the co-processor is capable of processing only non-interruptible instructions; the operating method comprises:
providing at least one batch command block corresponding to the task, comprising a sequence of non-interruptible instructions;
the micro-processor appointing the co-processor to execute the at least one batch command block to accomplish the task; and
when the task is complete, the co-processor outputting a response signal to the micro-processor.

10. The operating method as claimed in claim 9, wherein:
the embedded system further comprises a memory device storing the at least one batch command blocks; and
the operating method further comprising, when a task is assigned to the co-processor, the co-processor fetching the corresponding batch command block(s) from the memory device.

11. The operating method as claimed in claim 10, wherein the co-processor comprises:
a command queue, queuing non-interruptible instructions to be executed;
a execution engine, sequentially executing the non-interruptible instructions queued in the command queue; and
a support engine, accessed by the micro-processor to control the execution engine's execution flow;
the operating method further comprising:
the micro-processor setting a starting address of a batch command block corresponding to the task and sending an initial signal to the support engine.
the support engine fetching the batch command block according to the starting address, and extracting the non-interruptible instructions therein into the command queue;
triggering the execution engine to execute the non-interruptible instructions as long as the command queue is not empty; and
the support engine sending the response signal to the micro-processor upon completion of the task is complete.

12. The operating method as claimed in claim 11, further comprising:
the micro-processor compiling the non-interruptible instructions to generate the batch command block and storing it at the starting address of the memory device before sending the initial signal to the support engine;
indicating an execution result or an exception event of the task via the response signal; and
the micro-processor taking over the co-processor upon receipt of the response signal.

13. The operating method as claimed in claim 11, wherein:
the non-interruptible instructions comprise fundamental arithmetic instructions, memory access instructions and flow control instructions;
the execution engine executes the fundamental arithmetic instructions, the memory access instructions and flow control instructions

14. The operating method as claimed in claim 13, wherein the task is a mechanic control operation of an optical disk drive.

15. The operating method as claimed in claim 13, wherein the task is an arithmetic operation of adding, subtracting, multiplying and dividing.
